(19) United States
(12) Patent Application Publication
(10) Pub. No.: US 2003/0192567 A1
(43) Pub. Date: Oct. 16, 2003

(54) Method of making foreign matter harmless

(76) Inventors: Yoshihiro Koizumi, Tokyo-to (JP); Katsuhide Tsuchiya, Tokyo-to (JP)

Correspondence Address: LADAS & PARRY, 224 SOUTH MICHIGAN AVENUE, SUITE 1200, CHICAGO, IL, 60604, US

(21) Appl. No.: 10/411,767

(22) Filed: Apr. 11, 2003

(30) Foreign Application Priority Data
Apr. 12, 2002 (JP) 2002-111261

(51) Int. Cl. H01S 3/00; B08B 3/12

(52) U.S. Cl. 134/1; 264/482

(57) ABSTRACT

A main objective of the present invention is to provide a method of making a foreign matter harmless which can make the foreign matter, after attaching a pellicle, existing on a transmitting region of a reticle with a pellicle harmless, under pellicle attached condition. For attaining the above-described objective, the present invention provides a method of making a foreign matter harmless wherein a foreign matter existing on a transmitting region of a reticle with a pellicle is irradiated with laser, via the pellicle membrane to make the foreign matter harmless.

### BACKGROUND OF THE INVENTION

1) Field of the Invention

The present invention relates to a method of making a foreign matter harmless which enables making a foreign matter harmless existing inside a reticle with a pellicle, without peeling off the pellicle.

2) Description of the Related Art

Conventionally, as a method of forming a fine circuit pattern for manufacturing of semiconductors and liquid crystals, there is known a method of realizing a fine electron circuit of a semiconductor and the like by optically printing a circuit master drawing called photomask or reticle onto a wafer using a light transfer apparatus such as a stepper and the like. A reticle used as such a master drawing for transfer of a tine pattern onto a wafer is a base of an electron circuit pattern, therefore, it is required that such a pattern has no defect and has high precision.

For example, adhesion of a foreign matter to an exposure transmitting region of a reticle makes a shadow by exposure in conducting a transfer process, causing a serious abnormality on a circuit such as breaking and bridging. As a countermeasure against such problems, pollution by adhesion of a foreign matter is prevented by attaching a dust-proof part, so-called pellicle.

FIG. 1 is a schematic sectional view of such a reticle with a pellicle. Specifically explained on this FIG. 1, pellicle membranes 5 fixed by pellicle frames 4 are adhered with an adhesive material to a substrate 1 so as to sandwich a reticle 3 composed of a substrate 1 on which shading layers 2 are formed in a pattern. Thus, invasion of a foreign matter and the like into the interior is prevented by sealing the reticle with pellicles.

However, a problem arises after attaching such pellicles, in some cases that foreign matters exist on a transmitting region of the reticle with pellicles due to an organic material crystallized by the change of inside pressure, migration of foreign matters adhered on the pellicle frame and reticle surface, and the like. For treating such foreign matters exist on a transmitting region after attaching pellicles, a treatment is necessary which a pellicle attached is once peeled off and foreign matters are removed, then, the pellicle is attached again However, such a treatment needs a lot of jobs because repetition of detaching and attaching of pellicles, further, causes damage of a reticle, and the like.

### SUMMARY OF THE INVENTION

The present invention has been accomplished in view of the above-described problems, and a main objective is to provide a method of making a foreign matter harmless which can make the foreign matter existing on a transmitting region of a reticle with a pellicle harmless, under pellicle attached condition, after attaching a pellicle.

For attaining the above-described objective, the first aspect of the present invention provides a method of making a foreign matter harmless, wherein a foreign matter existing on a transmitting region of a reticle with a pellicle is irradiated with laser, via the pellicle membrane, to make the foreign matter harmless.

According to the first aspect, the present invention thus makes a foreign matter harmless by irradiating a foreign matter existing on a transmitting region of the reticle, with laser under condition of the pellicle attached to the reticle, after attaching a pellicle to a reticle. Therefore, there is no need to conduct treatments such as detaching and re-attaching of the pellicle in treating a foreign matter generated in the reticle with pellicle, so that the reticle manufacturing efficiency can be improved significantly.

In the present invention, the method of making a foreign matter harmless can be a method which decomposes or sublimates substances constituting the foreign matter into a size which is not transferred on the wafer. By decomposing or sublimating a foreign matter existing on a transmitting region of a reticle into materials of size not transferred on the wafer, it is possible to avoid transfer of unsuitable patterns due to a shadow of the foreign matter onto a wafer when the patterns are optically transferred onto a wafer and the like by using a reticle, and a reticle which an influence of the foreign matter is suppressed to the minimum level can be provided.

In the present invention, the method of making a foreign matter harmless can be a method which moves the foreign matter out of the transmitting region by laser. By conducting treatments such as moving a foreign matter out of a transmitting region, then, fixing the material, and the like, it is prevented to transfer a shade of the foreign matter onto a wafer, when the patterns of the reticle are transferred onto a wafer.

In the second aspect of the present invention, there is provided a method for manufacturing reticle, comprising a process of making a foreign matter harmless using the method of making a foreign matter harmless according to the first aspect. According to the second aspect, by adding the process of making a foreign matter harmless of the present invention to the method for manufacturing the reticle, it is possible to prevent invasion of a foreign matter from outside, further, it is possible to easily produce a reticle capable of suppressing an influence of a foreign matter generated inside to the minimum level.

The present invention makes a foreign matter harmless by, after attaching a pellicle to a reticle, irradiating a foreign matter existing on a transmitting region of the reticle with laser under condition of the pellicle attached to the reticle, therefore, there is no need to conduct treatments such as detaching and re-attaching of the pellicle in treating a foreign matter generated in the reticle with pellicle, so that the reticle manufacturing efficiency can be improved significantly.

### BRIEF DESCRIPTION OF THE DRAWINGS

FIG. 1 is a schematic sectional view of a reticle with a pellicle.

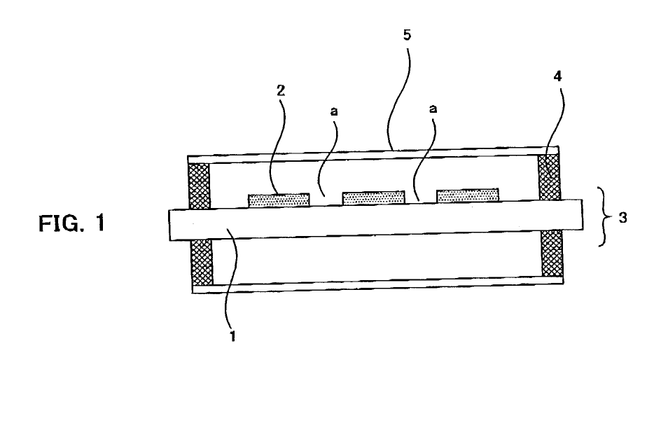

### DESCRIPTION OF THE PREFERRED EMBODIMENTS

The method of making a foreign matter harmless and a method for manufacturing reticle by the method of making a foreign matter harmless, of the present invention, will be explained below.

The method of making a foreign matter harmless of the present invention is such that a foreign matter existing on a transmitting region of a reticle with a pellicle is irradiated with laser, via the pellicle membrane to make the foreign matter harmless.

Here, the transmitting region of a reticle indicates a region on which a shading layer is not formed and transmits light in transferring patterns onto a wafer using a reticle.

The present invention has a feature that after attaching a pellicle, a foreign matter existing on a transmitting region of a reticle is made harmless under pellicle attached condition. Therefore, a foreign matter can be made harmless under pellicle attached condition in the present invention while conventionally, it is impossible to avoid disposing a reticle or jobs are necessary such as detaching a pellicle and treating the foreign matter, then, re-attaching a pellicle, so that it is possible to increase yield and improve manufacturing efficiency in manufacturing a reticle with a pellicle.

The method of making a foreign matter harmless of the present invention having such merit is described in detail below.

(Method of Making a Foreign Matter Harmless)

To make a foreign matter harmless in the present invention, is to treat a foreign matter to give a condition that a shade of a foreign matter is not recognized by a light transfer apparatus such as a stepper and the like, and unsuitable patterns are not transferred onto a wafer, in transferring pattern onto a wafer and the like by using a reticle with a pellicle. Therefore, for method of making the foreign matter to give such a harmless condition, it is not particularly restricted, as long as the foreign matter is treated to give a condition that the shade of a foreign matter is not transferred in transferring. Specifically, there are methods that substances constituting a foreign matter are decomposed or sublimated to be the size not being transferred on the wafer, or a foreign matter is moved onto a shading layer, and the like.

In the present invention, for method enabling the above method of making the foreign matter harmless is to irradiate a foreign matter existing on a pattern transmitting region on a reticle with laser via a pellicle membrane. For a basic embodiment, the laser having a wavelength in the range of 350 ma to 550 nm is used.

Such specific methods of making a foreign matter harmless by using laser, that is, making the foreign matter harmless by decomposition or sublimation, and by moving as described above will be explained below.

(1) Making a Foreign Matter Harmless by Decomposition or Sublimation

As a first embodiment of the method of making a foreign matter harmless, there is a method of making a foreign matter harmless in which substances constituting the foreign matter are decomposed or sublimated to be the size not being transferred on the wafer. As the laser used for enabling making a foreign matter harmless, it is necessary to use laser having wavelength which acts on the foreign matter. The foreign matter to be made harmless is not particularly restricted, but the foreign matter is generally organic foreign matter.

Specifically, by using laser having wavelength absorbed by a foreign matter, it is possible to heat a foreign matter in irradiating the foreign matter with laser, and by this, the foreign matter can be decomposed or sublimated to be made harmless. Further, for example, by using laser having wavelength which acts directly on a molecular chain of molecules constituting a foreign matter, the foreign matter is decomposed to be made harmless.

As a typical example, of a foreign matter to be made harmless by such methods, are residues of photoresists used in mask manufacturing Particularly, residues of photoresist which have a novolak resin and quinonediazide, a novolak resin and polymethylpentene-1-sulfone, chloromethylated polystyrene and the like as main components, and residue of chemical amplification-type resists obtained by mixing a novolak resin or phenol resin with an inhibitor, acid generator and the like are the typical examples. In such photoresist residues, energy absorption occurs by 10to 20% at a laser wavelength of 350 nm and by about 50% at a laser wavelength of 500 nm, so that a foreign matter is decomposed or sublimated. As the laser wavelength used here, those in the range from 350 nm to 550 nm are preferably used, and a foreign matter can be made harmless without problems since by making focal length of the object lens of a laser repair systems longer to avoid focusing on a pellicle membrane so that energy density is low and the pellicle is not damaged.

(2) Making a Foreign Matter Harmless by Movement

Next, as a second embodiment of making a foreign matter harmless, a method of removing a foreign matter out of a transmitting region by laser will be explained below.

In this case, a foreign matter is moved out of a transmitting region, and generally, it is preferable that, subsequently, the foreign matter is fixed at the moved position. When the foreign matter is in the form of block or is very light, there is a case which by absorbing laser energy in moving by impact of laser, it is fused and fixed on a place having low temperature such as chromium and the like, after moving.

The kind of laser used in such a method of moving a foreign matter to make harmless, is not particularly restricted in laser wavelength, and the like.

Further, the foreign matter made harmless by this method is not particularly restricted, but the foreign matter is generally inorganic foreign matter.

(Method for Manufacturing Reticle)

In the present invention, when the presence of a foreign matter is recognized in a transmitting region of a reticle after attaching of a reticle after manufacturing of a reticle with a pellicle by a known manufacturing method, a reticle with a pellicle which the foreign matter is made harmless can be manufactured by conducting a process of making the foreign matter harmless by the method of making a foreign matter harmless in the present invention as described above.

By conducting the process of making the foreign matter harmless of the present invention, the manufacturing process can be simplified significantly and the manufacturing efficiency can be improved, since it is not necessity to detach and re-attach a pellicle conventionally conducted.

Explanations of other processes in the method for manufacturing reticle of the present invention are omitted here, since various methods conventionally conducted can be used in combination.

The present invention is not limited to the above-described embodiments. The above-described embodiments are only examples, and those having substantially the same constitution and performing the same action and effect as the technological ideas described in the claims of the present invention are anyway included in the technological range of the present invention.

What is claimed is:

1. A method of making a foreign matter harmless, wherein a foreign matter existing on a transmitting region of a reticle with a pellicle is irradiated with laser, via the pellicle membrane to make the foreign matter harmless.

2. The method of making a foreign matter harmless according to claim 1, wherein to make the foreign matter harmless is to decompose or sublimate substances constituting the foreign matter by laser into a size which is not transferred on a wafer.

3. The method of making a foreign matter harmless according to claim 1, wherein to make the foreign matter harmless is to move the foreign matter out of the transmitting region by laser.

4. A method for manufacturing reticle, comprising a process of making a foreign matter harmless by the method of making a foreign matter harmless according to claim 1.

5. A method for manufacturing reticle, comprising a process of making a foreign matter harmless by the method of making a foreign matter harmless according to claim 2.

6. A method for manufacturing reticle, comprising a process of making a foreign matter harmless by the method of making a foreign matter harmless according to claim 3.
